(19) United States
(12) Patent Application Publication
(10) Pub. No.: US 2015/0105961 A1
(43) Pub. Date: Apr. 16, 2015

(54) AUTONOMOUS VEHICLE AND TASK MODELLING

(71) Applicant: Glenn Michael Callow, Bristol (GB)

(72) Inventor: Glenn Michael Callow, Bristol (GB)

(73) Assignee: BAE SYSTEMS PLC, London (UK)

(21) Appl. No.: 14/344,247

(22) PCT Filed: Sep. 12, 2012
(86) PCT No.: PCT/GB2012/052249

§ 371 Date: Dec. 5, 2014

(30) Foreign Application Priority Data
Sep. 15, 2011 (GB) 1116221.1

(51) Int. Cl. G05D 1/02; G06F 9/44

(52) U.S. Cl. CPC G05D 1/021; G06F 8/35
USPC 701/23

(57) ABSTRACT

A method, and apparatus for the performance thereof, comprising providing a first meta-model (8, 9) thereby providing a basis for a first model; providing a second meta-model (8, 9) thereby providing a basis for a second model; providing the first model; and using the first model and a set of transformations between the first and second meta-models (8, 9), determining the second model; wherein either, the first model is of a given task; the second model is of an autonomous vehicle (2); and the method further comprises providing the autonomous vehicle (2); or the first model corresponds to a given autonomous vehicle (2); the second model corresponds to a task; and the method further comprises using the given autonomous vehicle (2) to perform the task.

### FIELD OF THE INVENTION

The present invention relates to the modelling and provision of an autonomous vehicle capable of performing a given task, and the modelling and performance of a task that is able to be performed by a given autonomous vehicle.

### BACKGROUND

Typically autonomous systems (e.g. autonomous vehicles) are used to achieve goals with reduced (or no) human interaction.

It is known to assess, or validate, an autonomous system e.g. by determining whether or not it has the necessary capabilities to support an operator in achieving the task. This validation of an autonomous system is primarily a design-time activity with a focus on ensuring that the system does what a user wants it to do, and that this system is reliable, available, dependable, safe, etc.

However, it is desired to identify a set of functions or capabilities that would allow an autonomous system to perform a given task.

### SUMMARY OF THE INVENTION

In a first aspect, the present invention provides a method comprising: providing a first meta-model, the first meta-model providing a basis for a first model; providing a second meta-model, the second meta-model providing a basis for a second model; providing a first model, the first model being an instantiation of the first meta-model; and using the first model and a set of transformations between the first meta-model and the second meta-model, determining the second model, the second model being an instantiation of the second meta-model; wherein: either, the first model corresponds to a given task; the second model corresponds to an autonomous vehicle; and the method further comprises providing an autonomous vehicle as specified by the second model; or, the first model corresponds to a given autonomous vehicle; the second model corresponds to a task; and the method further comprises using the given autonomous vehicle to perform the task specified by the second model.

The method may further comprise providing a third meta-model, the third meta-model providing a basis for specifying an intermediate model, wherein the step of determining a second model may comprise: using the first model and a set of transformations between the first meta-model and the third meta-model, determining a third model, the third model being an instantiation of the third meta-model; and using the third model and a set of transformations between the third meta-model and the second meta-model, determining the second model.

The step of determining a third model may comprise: using the first model and a set of transformations between the first meta-model and the third meta-model, determining a partially complete model; and determining the third model by completing the partially complete model.

The step of completing the partially complete model may comprise: determining a finite set of instantiations of the third meta-model; and dependent upon constraints specified in the third meta-model, setting values of attributes of one or more of the instances.

The step of completing the partially complete model may further comprise explicitly relating instantiations in the finite set by generating or removing an association and/or containment relationship between those instantiations.

The step of completing the partially complete model may comprise representing the problem of completing the partially complete model as a Constraint Satisfaction Problem, and solving the Constraint Satisfaction Problem.

The step of completing the partially complete model may further comprise representing the Constraint Satisfaction Problem as a Linear Program in the Gnu Mathematical Programming Language, and solving the Constraint Satisfaction Problem using a Mixed Integer Linear Programming solver.

An objective of the step of completing the partially complete model may be to complete the partially complete model by making a minimum number of changes to the partially complete model.

The method may further comprise using one or more sensors to provide data about environmental conditions in which the autonomous vehicle is to operate, and using that data in the method.

Each meta-model and model may be in accordance with the Meta Object Facility (MOF) approach for the development of software systems.

In a further aspect, the present invention provides apparatus comprising one or more processors arranged to, using a first model, the first model being an instantiation of a first meta-model, and a set of transformations between the first meta-model and a second meta-model, determine a second model, the second model being an instantiation of the second meta-model; wherein: either, the first model corresponds to a given task; the second model corresponds to an autonomous vehicle; and the apparatus further comprises means for providing the autonomous vehicle specified by the second model; or, the first model corresponds to a given autonomous vehicle; the second model corresponds to a task; and the apparatus further comprises the given autonomous vehicle.

The means for providing the autonomous vehicle specified by the second model may comprise means for selecting an existing autonomous vehicle.

The means for providing the autonomous vehicle specified by the second model may comprise means for adapting an existing autonomous vehicle.

In a further aspect, the present invention provides an autonomous vehicle comprising one or more processors arranged to, using a first model, the first model being an instantiation of a first meta-model, and a set of transformations between the first meta-model and a second meta-model, determine a second model, the second model being an instantiation of the second meta-model; wherein: the first model corresponds to the autonomous vehicle; and the second model corresponds to a task.

The autonomous vehicle may be a land-based autonomous vehicle.

In a further aspect, the present invention provides a program or plurality of programs arranged such that when executed by a computer system or one or more processors it/they cause the computer system or the one or more processors to operate in accordance with the method of any of the above aspects.

In a further aspect, the present invention provides a machine readable storage medium storing a program or at least one of the plurality of programs according to the above aspect.

### BRIEF DESCRIPTION OF THE DRAWINGS

FIG. 1 is a schematic illustration (not to scale) of a scenario in which an embodiment of a method of generating a model for a vehicle that specifies capabilities of the vehicle that would ensure that the vehicle can perform a given task is implemented;

FIG. 2 is a schematic illustration (not to scale) of an embodiment of a system for generating the model for the vehicle;

FIG. 3 is a process flow chart showing certain steps of the method for generating the model for the vehicle; and

FIG. 4 is a process flow chart showing certain steps of the method by which, at step s14 of the method of FIG. 3, a processor completes a partial mapping model to produce a complete, viable mapping model.

### DETAILED DESCRIPTION

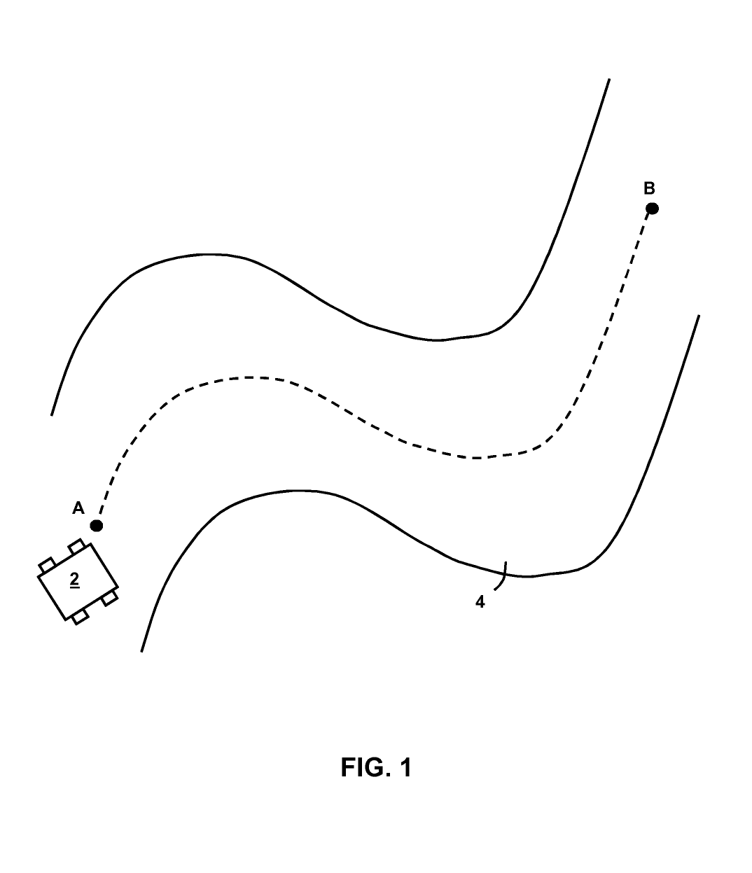

FIG. 1 is a schematic illustration (not to scale) of a scenario in which an embodiment of a method of generating a model of a vehicle that is capable of performing a given task is implemented.

In this embodiment, the framework used for a model generation process (i.e. generating/specifying a model) is the Meta Object Facility (MOF) approach. More information about MOF may be found in OMG, “Meta-model Object Facility (MOF) Core Specification v2.0”, formal/2006 Jan. 1, 2006, which is incorporated herein by reference.

In this embodiment, the MOF is provided by software. It provides a set of guidelines or rules for the specification of a model of a system. The terminology “model” is used herein to refer to a computational model which is a representation that describes a particular system.

FIG. 1 schematically shows a vehicle 2 positioned on a road 4.

In this embodiment, the vehicle 2 is an autonomous land-based vehicle. The terminology “autonomous” is used herein to refer to a system that, to some extent, operates independently from a human, that may observe and/or affect some environment beyond its system boundary, and that has some capability to make decisions in response to a change in its own state and/or in its environment.

In this scenario, the road 4 has a tarmac surface and is five metres wide.

In this scenario, it is a task to autonomously navigate along the road 4, from a first point A to a second point B.

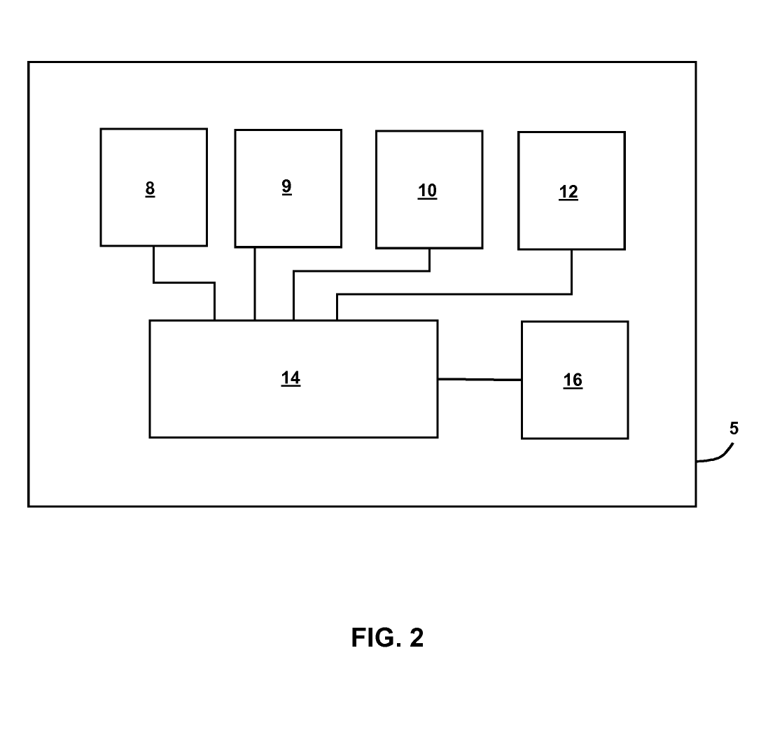

An embodiment of a system for generating a model for the vehicle 2 that specifies capabilities of the vehicle 2 that would ensure that the vehicle 2 can perform the task (i.e. autonomously navigate from point A to point B) is described in more detail later below with reference to FIG. 2.

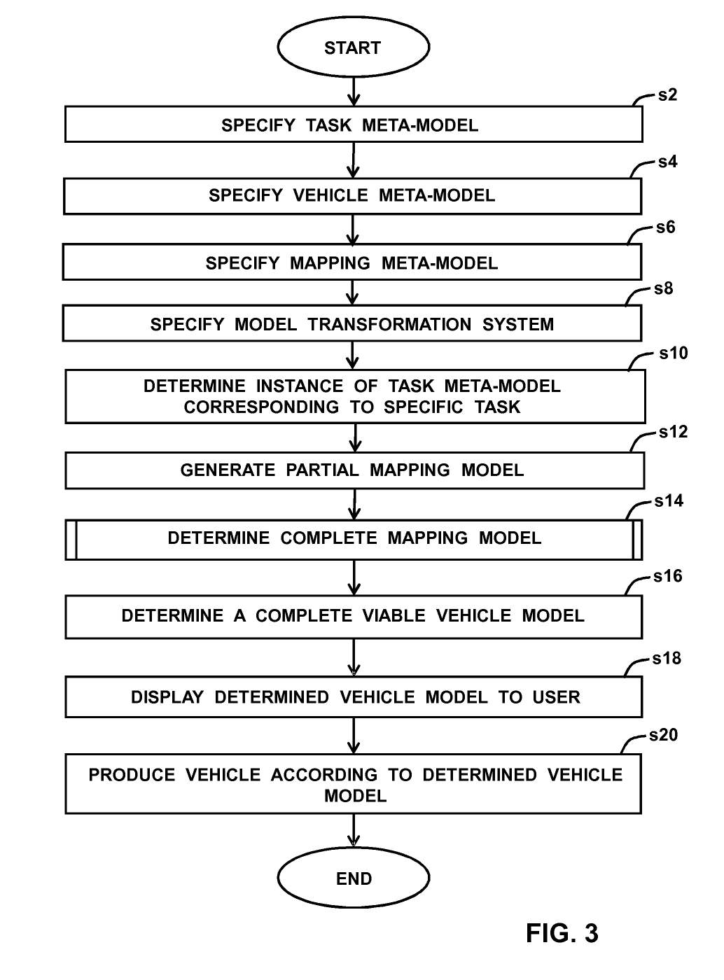

An embodiment of a method of generating a model for the vehicle 2 that specifies capabilities of the vehicle 2 that would ensure that the vehicle 2 can perform the task (i.e. autonomously navigate from point A to point B) is described in more detail later below with reference to FIG. 3.

In this embodiment, the method of generating a model for the vehicle 2 that specifies capabilities of the vehicle 2 that would ensure that the vehicle 2 can perform the task is implemented using a Query/View/Transformation (QVT) transformation language. More information on the QVT transformation language may be found in “Meta Object Facility (MOF) 2.0 Query/View/Transformation Specification” OMG, OMG Document formal/2008 Apr. 3, January 2005, which is incorporated herein by reference

FIG. 2 is a schematic illustration (not to scale) of an embodiment of the system for generating a model for the vehicle 2 that specifies capabilities of the vehicle 2 that would ensure that the vehicle 2 can perform the task. This system is hereinafter referred to as “the system” and is indicated in FIG. 2 by the reference numeral 6.

In this embodiment, the system 6 comprises a task meta-model 8, a vehicle meta-model 9, a mapping meta-model 10, a model transform system 12 a processor 14, and a display 16.

In this embodiment, the task meta-model 8 is a meta-model according to the MOF paradigm.

In this embodiment, the task meta-model 8 describes the capabilities that perform a generic task, and allows for the specification of a performance level that those capabilities need to be provided with. A particular instantiation of the task meta-model 8 describes the particular task (i.e. autonomously navigating along the road 4 from point A to point B). This task meta-model 8 defines a Domain Specific Modelling Language (DSML) which is used to describe task models.

Thus a model for the task of autonomously navigating along the road 4 from point A to point B is, in effect, an instantiation (e.g. a representation at a certain instant) of the task meta-model 8, i.e. the task meta-model 8 provides a basis for the a model of the specific task.

In this embodiment, the model of the specific task (i.e. an instantiation of the task meta-model 8) specifies that the vehicle is tasked to travel from the first point A to the second point B along the road 4. Also, the model of the specific task is a Computation Independent Model (CIM). In this embodiment, the CIM is represented using the Domain Specific Modelling Language defined by the task meta-model 8. This tends to provide that a model for a specific task may be easily and quickly specified by a user of the vehicle 2.

In this embodiment, the vehicle meta-model 9 is a meta-model according to the MOF paradigm.

In this embodiment, the vehicle meta-model 9 describes a set of (generic) vehicle components, and/or a set of vehicle functions that make up a specific type of vehicle (in this case a generic land-based autonomous vehicle).

In this embodiment, the vehicle meta-model 9 is a Platform Independent Model (PIM). In this embodiment, the vehicle meta-model 9 is a generic model corresponding to the vehicle 2. This generic model will be used, as described in more detail later below with reference to FIG. 3, to determine a specific vehicle model for the vehicle 2.

In this embodiment, the vehicle meta-model 9 is a model for a generic vehicle, and a specific vehicle is specified by a specific instantiation of the vehicle meta-model 9.

In this embodiment, a specific instantiation of the vehicle meta-model 9 is a model that describes the following (the vehicle meta-model 9 describes corresponding functionalities and structure for the generic vehicle): the functionality of hardware and software components of that specific vehicle, the structure of that specific vehicle (including, for example, the organisation of components within that vehicle, and/or the structure of data flowing in and out of that vehicle), the behaviour of that specific vehicle (including, for example, a current state of that vehicle, descriptions of sequences or algorithms used by that vehicle, a specification of the vehicle dynamics, a specification of the vehicle's ability to localise itself with respect to its surroundings, and a specification of the decision making abilities of that vehicle), and any systems analysis associated with that specific vehicle.

In this embodiment, the mapping meta-model 10 is a meta-model according to the MOF paradigm.

In this embodiment, the mapping meta-model 10 which provides a link between functions capable of being performed by a generic vehicle and capabilities needed to perform a generic task. Systems analysis between functions and capabilities resides in this domain.

Thus, in this embodiment a particular, specific task (e.g. the task of autonomously navigating from A to B) is an instance of the task meta-model 8. Also, specific vehicle set-up (possibly at a specific point in time), is an instance of the vehicle meta-model 9. A specific instance of the mapping meta-model 10 that maps the specific task model to the specific vehicle model (or vice versa) may be used to verify whether the specific vehicle can achieve the specific task.

In this embodiment, the meta-models 8, 9, 10 provide domains within which specific task/vehicle/mapping models may be expressed. In this embodiment, the domains are organised such that they are loosely coupled. In particular, changes to a domain are localised to that domain as far as possible (e.g. changing a model associated with a specific vehicle would have no effects on a model for a task).

In this embodiment, the model transform system 12 comprises descriptions of mappings (or relations) that are possible between the meta-models 8, 9, 10 and any restrictions/limitations thereon. In other words, the model transform system 12 comprises descriptions of relations between meta-models 8, 9, 10.

In this embodiment, the information in the model transform system 12 is defined by a user (such as a designer or operator of the vehicle 2).

The model transform system 12 will be described in more detail later below with reference to FIG. 3.

In this embodiment, the processor 14 uses the task meta-model 8, vehicle meta-model 9, the mapping meta-model 10, and the model transform system 12 to identify or determine a set of functions that will allow the vehicle 2 to complete the specific task of autonomously navigating from A to B along the road 4. This is described in more detail later below with reference to FIG. 3.

In this embodiment the display 16 displays the result determined by the processor 14 to the user (not shown). The display 16 may, for example, be a screen.

FIG. 3 is a process flow chart showing certain steps of the method for generating a model for the vehicle 2 that specifies capabilities of the vehicle 2 that would ensure that the vehicle 2 can perform the task.

At step s2, the task meta-model 8 is specified.

In this embodiment, the task meta-model 8 describes the capabilities that achieve a generic task, and allows for the specification of a performance level that those capabilities need to be provided with. A particular instantiation of the task meta-model 8 describes the specific task of autonomously navigating from point A to point B.

At step s4, the vehicle meta-model 9 is specified.

In this embodiment, the vehicle meta-model 9 a set of (generic) vehicle components, and/or a set of vehicle functions that make up a type of vehicle (in this case an autonomous land-based vehicle).

At step s6, the mapping meta-model 10 is specified.

In this embodiment, the mapping meta-model 10 which provides a link between functions capable of being performed by a generic vehicle and capabilities needed to perform a generic task.

At step s8, the model transform system 12 is specified.

In this embodiment, the model transform system 12 is specified by a designer of the autonomous vehicle 2. In this embodiment, the model transform system 12 comprises a set of possible mappings (or relations) between the task meta-model 8 and the mapping meta-model 10 (and vice versa), and between the mapping meta-model 10 and the vehicle meta-model 9 (and vice versa)

These relations describe how an element of the task meta-model 8 (e.g. requiring that the vehicle 2 can navigate autonomously) relates to the links provided by the mapping meta-model 10. Also, the relations describe how an element of the vehicle meta-model 9 (e.g. that a vehicle has the capability to navigate autonomously) relates to the links provided by the mapping meta-model 10.

At step s10, an instance of the task meta-model 8 that corresponds to the specific task of autonomously navigating along the road 4 from point A to point B is determined. Thus, a model for the specific task is determined.

At step s12, the instantiation of the task meta-model 8 that corresponds to the specific task of autonomously navigating along the road 4 from point A to point B and the relevant mappings within the model transform system 12 (i.e. the transformations that relate the task meta-model 8 to the mapping meta-model 10) are used to generate a partial mapping model (using the mapping meta-model 10 as a basis). The terminology “partial model” is used herein to refer to a model that is an incomplete or partial instantiation of the relevant meta-model basis.

In this embodiment, only a partial mapping model may be generated at s12. This is because only a task model (as opposed to both a task model and a vehicle model) is provided/known. Thus, at this stage there is insufficient information to complete the mapping model.

In this embodiment, the partial mapping model is generated by the processor 14.

At step s14, the processor 14 completes the partial mapping model to produce a complete, viable mapping model.

In this embodiment, a set of constraints specified/contained in the mapping meta-model 10 are used to complete the partial mapping model.

The generation of a complete, valid mapping model is, in effect, a Constraint Satisfaction Problem.

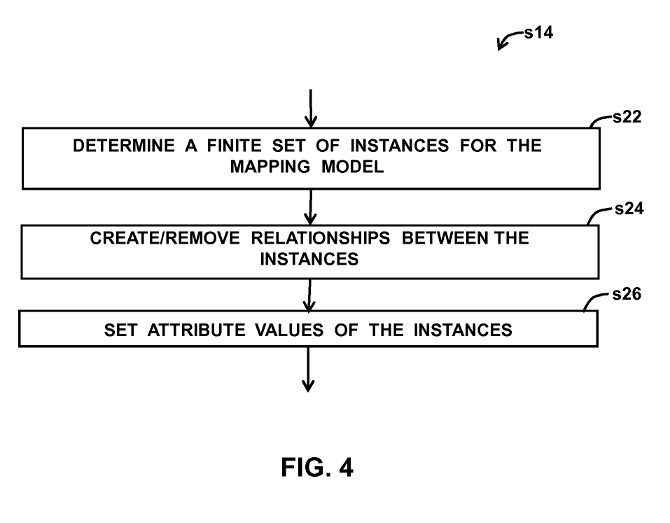

The method by which the Constraint Satisfaction Problem is addressed and by which a complete, valid mapping model is generated is described in more detail later below with reference to FIG. 4.

At step s16, the processor 14 determines a viable, complete vehicle model.

In this embodiment the completed mapping model (determined at step s14 above) and the relevant mappings within the model transform system 12 (i.e. the transformations that relate the mapping meta-model 10 to the vehicle meta-model 9) are used to generate the viable vehicle model (using the vehicle meta-model 9 as a basis).

In this embodiment, any set of vehicle functions that can achieve the task is considered viable.

Thus, if a mapping model and a vehicle model can be generated using the specified model transformations (in the model transform system 12), and that these models conform to the relevant meta-models (i.e. the mapping meta-model 10 and the vehicle meta-model 9 respectively), then a set of vehicle functions (as specified in the generated vehicle model) have been identified that can achieve the task (as specified in the specific task model determined at step s10).

At step s18, the display 16 displays the results of step s16, i.e. the vehicle model for the vehicle 2 that ensures the vehicle 2 is capable of performing the specific task is displayed to the user).

In this embodiment, the results of step s16 are displayed to the user. However, in other embodiments such results are used in different ways instead of or in addition to being displayed to the user. For example, data corresponding to the result may provide an input to other systems of the autonomous vehicle 2, e.g. so that the vehicle perform a particular action depending on the result.

At step s20, the vehicle 2 is changed or modified such that it conforms to the vehicle model determined at step s16 and displayed to the user at step s18. In particular, the onboard systems of the vehicle 2 are changed such that it conforms to the determined specific vehicle model.

In other embodiments, an autonomous vehicle that conforms to the determined specific vehicle model may be provided in a different way, for example, such a vehicle may be built or assembled such that the determined vehicle model is satisfied.

Thus, a method of generating a model for the vehicle 2 that specifies capabilities of the vehicle 2 that would ensure that the vehicle 2 can perform the task is provided.

In this embodiment, the model transformations (contained in the model transform system 12) that transform between the meta-models (and models) are relational/declarative type transformations. A set of these transformations comprises a series of consistency relations between the source and target models. In the case where these relations are violated (i.e. a source model and target model are inconsistent given the relation), the transformation engine may be used to determine how the target model is modified to allow the consistency relation to hold. Relational specifications typically support bi-directional operational and, in addition to supporting model creation, support model synchronisation (updates from a source model are propagated to an existing target model and vice versa) and consistency checking (checking whether consistency relations are violated, and reporting the instances where they are without modifying the existing models). Examples of transformation languages that support relational/declarative specifications include Triple Graph Grammars (TGG), Query/View/Transformation (QVT) Relation, and Relational Matrix approaches.

In other embodiments, different types of transformation may be used instead of or in addition to the relational/declarative type transformations. For example, operational/imperative type transformations may also be used. A set of these transformations may comprise a series of operations that define how a target model should be created/edited based on information in a source model. A transformation engine may be used to execute sequences of operations based on the constructs contained within the source model. These specifications may be unidirectional, and are primarily suited to target model creation. Transformation languages that support this approach include the Atlas Transformation Language and QVT-Operational.

In order to use model transformations to determine one model from another (given the relevant meta-models and a set of relations) any appropriate method may be used. For example, the use of matrix-based relational transformations to trace operational mission threads through to system threads, as described in “Using relational model transformations to reduce complexity in SoS requirements traceability: Preliminary investigation”, C. Dickerson, System of Systems Engineering (SoSE), 2010 5th International Conference (which is incorporated herein by reference), may be used. TGGs and/or QVT-Relation representations may also be used. Transformations in these representations comprise a series of rules (in the case of TGGs) or relations (in the case of QVT-Relation) which describe a consistency relation between a sub-set of a source and target meta-model. These meta-models can be distinct, with relations specified between these distinct meta-models. Each consistency relation has a “context”. This context constrains when the relation can be applied, and may also bind variables within the relation. Model Transformation engines for both approaches may then used to create, synchronise, or check consistency, based on the meta-models, supplied conforming models and model transformation specification.

In this embodiment, QVT-Relation is used as the relational transformation language. Tools for implementing this relational transformation language tend to be readily available (e.g. the MediniQVT tool which tends to integrate well with the Eclipse Modelling Framework). However, in other embodiments one or more different languages instead of or in addition to QVT-Relation may be used. For example, TGGs tend to provide a similar capability to QVT-Relation.

What will now be described is the method by which, at step s14 of the method of FIG. 3, the processor 14 completes the partial mapping model to produce a complete, viable mapping model.

In this domain specific meta-models, and associated, partially complete instances of those meta-models, are represented as Mixed Integer Linear Programming (MILP) problems. This approach advantageously provides that completed versions of partial models may be generated.

In this embodiment, the process by which the partial mapping model is completed is based on a process described in “Verification of UML/OCL Class Diagrams using Constraint Programming”, J. Cabot, R. Clarisó and D. Riera, Proceedings of the 2008 IEEE International Conference on Software Testing Verification and Validation Workshop, Washington, D.C., USA: IEEE Computer Society, 2008, which is incorporated herein by reference. Cabot et al. provide a means for specifying a Unified Modelling Language (UML) class diagram (a meta-model in the terminology used in this description) as a Constraint Satisfaction Problem (CSP) and then determining if the diagram is satisfiable. Sets of valid model instances, attributes and constraints are generated if it is determined that the diagram is satisfiable. Class attributes are supported, as are arbitrary Object Constraint Language (OCL) based constraints.

However, the process described in Cabot et al. does not explicitly support both association and containment relationships which have different semantics as part of a meta-model. Including and managing these different types of relations tends to add complexity when calculating the number of instances, and associated relationships, that are to be created.

Furthermore, the process described in Cabot et al. does not consider pre-existing partial models. The approach described in Cabot et al. tends only to generate a new problem from scratch and tends not to address how an existing model needs to be modified in order to be compliant with the relevant meta-model.

The process implemented in this embodiment to complete the partial mapping model is based upon the process described in Cabot et al. and includes the use of composition relationships.

Also, the process used in this embodiment to complete the partial mapping model includes the manipulation of partial models (including both under and over specified partial models, and including the manipulation of relevant instances, associations and attributes).

Also, the process used in this embodiment to complete the partial mapping model includes parsimonious manipulation of models, i.e. the number of modifications made to the models in order to make those models compliant with their associated meta-model is substantially minimal.

Also, in this embodiment a linear programming solver (e.g. the GNU Linear Programming Kit) is used to address the Constraint Satisfaction Problem represented as a Linear Program in the GNU Mathematical Programming Language (GMPL).

FIG. 4 is a process flow chart showing certain steps of the method by which, at step s14 of the method of FIG. 3, the processor 14 completes the partial mapping model to produce a complete, viable mapping model.

For convenience, in the description of FIG. 4, the notation used in Cabot et al. is utilised.

At step s22, a finite set of instances for the mapping model is determined. In this embodiment, each of the instances in this finite set is a possible completed mapping model (i.e. a completed version of the partial mapping model that was determined at step s12 as described in more detail above with reference to FIG. 3). The finite set is determined using the mapping meta-model 10 and the partial mapping model.

In this embodiment, the mapping meta-model 10 comprises a set of classes C, two sets of associations, Asₗ and Asᵤ, and two sets of Containment Associations, Coₗ and Coᵤ.

In this embodiment, these sets are defined using the following 3-tuples:

∀(c₁,c₂,n)εAsₗ|c₁εC,c₂εC

∀(c₁,c₂,n)εAsᵤ|c₁εC,c₂εC

∀(c₁,c₂,n)εCoₗ|c₁εC,c₂εC

∀(c₁,c₂,n)εCoᵤ|c₁εC,c₂εC

where n is the cardinality for the end point of that association or relationship, and whose domain is the set of positive integers.

A bi-directional many-to-many association between classes is represented as two distinct 3-tuples.

The root node is defined within the meta-model as follows:

r=c:cεC

Attributes within classes are defined as follows:

A_{c}={a₁,a₂, . . . ,aₙ}

where cεC and aᵢ represent the names of the attributes associated with class c.

In this embodiment, a mapping model (i.e. an instantiation of the mapping meta model 10) is represented as a set of instances of classes, associations and compositions. This set of class instances, I_{c}, is represented using the following 2-tuple:

∀(i,c)εI_{c}|cεC

In each 2-tuple, i refers to the unique object identifier for that instance. A set of instances of associations and a set of instances of compositions, Iₐₛ and I_{co} respectively, similarly consist of 2-tuples as follows.

∀(i₁,i₂)εIₐₛ,∃c₁εC,∃c₂εC|(i₁,c₁)εI_{c}̂(i₂,c₂)εI_{c}

∀(i₁,i₂)εI_{co},∃c₁εC,∃c₂εC|(i₁,c₁)εI_{c}̂(i₂,c₂)εI_{c}

In this embodiment, attribute values in the mapping model are represented as sets. Also, each instance of a class comprises a distinct set which contains 2-tuples which reflect an attribute/value pair, i.e.

∀(i,c)εI_{c}

Iᵢ={(a₁,v₁),(a₂,v₂), . . . ,(aₙ,vₙ)}

In this embodiment, one or more decision variables are used to provide that step s22 can be addressed as a linear programming problem.

In this embodiment, the decision variables used are contained within two vectors.

A first vector m has a dimension of size C (i.e. there is one element in m for each class cεC). Each element of the first vector m is in the domain of non-negative integers, and the value of each element is indicative of how many instances of the corresponding class need to be added to the partial mapping model in order to make it compliant with the mapping meta-model 10.

A second vector d has a dimension of size I_{c} (i.e. there is one element in d for each class instance). Each element of the second vector d is in the binary domain, and the value of each element is indicative of an existing instance in the partial model. In this embodiment, a value of 1 in the second vector d indicates an instance that should be removed from the partial mapping model. Also, a value of 0 in the second vector d indicates an instance that should not be removed from the partial mapping model.

Constraints that incorporate the above described decision vectors are used in the linear programming problem of step s22

Constraints which take into account the composition relationship of the mapping meta-model 10 are used in the linear programming problem of step s22.

Also, an objective function is used in the linear programming problem of step s22. In this embodiment this objective function is as follows:

$$min ( {\sum }_{( i , c ) ∈ {I}_{c}} {m}_{c} + {d}_{( i , c )} )$$

This objective function provides that the number of changes performed on the partial mapping model to ensure that it conforms to the mapping meta-model 10 is minimised.

In this embodiment, at step s22 an MILP solver is used to solve the above described linear programming problem. This generates an updated set I_{c} which comprises a number of (i,c)-pairs dependent on the mapping meta-model 10, an updated set of instances of associations Iₐₛ, and a set of instances of compositions I_{co}. Any association or composition relationships which included deleted instances have been removed.

At step s24, relevant relationships (composition and/or associations) between instances in the finite set of instances are created or removed as desired.

In this embodiment, this step (step s24) is performed to explicitly relate the instances in the updated sets I_{c}, Iₐₛ and I_{co} that were generated at step s22 as described above. This is performed by generating and/or removing association and containment relationships between instances as required.

In this embodiment further decision variables are used to perform step s24. In this embodiment, these further decision variables are xᵢⱼ, yᵢⱼ, pᵢⱼ, and qᵢⱼ

xᵢⱼ is a binary matrix. A value of 1 in the ijth element indicates that a containment relationship should be added between instances i and j from I_{co}.

yᵢⱼ is a binary matrix. A value of 1 in the ijth element indicates that a containment relationship should be removed between instances i and j from I_{co}.

pᵢⱼ is a binary matrix. A value of 1 in the ijth element indicates that an association relationship should be added between instances i and j from Iₐₛ.

qᵢⱼ is a binary matrix. A value of 1 in the ijth element indicates that an association relationship should be removed between instances i and j from Iₐₛ.

The associated constraints are as follows:

$$∀ ( {i}_{1} , {c}_{1} ) ∈ {I}_{c} , ( {i}_{2} , {c}_{2} ) ∈ {I}_{c} : {c}_{1} \neq {c}_{2} ∃ ( {c}_{1} , {c}_{2} , n ) ∈ {Co}_{l} , \\ n \leq {x}_{{i}_{1} {i}_{2}} + {\sum }_{( {i}_{1} , {i}_{2} ) ∈ {I}_{co}} 1$$

$$∀ ( {i}_{1} , {c}_{1} ) ∈ {I}_{c} , ( {i}_{2} , {c}_{2} ) ∈ {I}_{c} : {c}_{1} \neq {c}_{2} ∃ ( {c}_{1} , {c}_{2} , n ) ∈ {Co}_{u} , \\ n \geq {\sum }_{( {i}_{1} , {i}_{2} ) ∈ {I}_{co}} 1 - {y}_{{i}_{1} {i}_{2}}$$

$$∀ ( {i}_{1} , {c}_{1} ) ∈ {I}_{c} , ( {i}_{2} , {c}_{2} ) ∈ {I}_{c} : {c}_{1} \neq {c}_{2} ∃ ( {c}_{1} , {c}_{2} , n ) ∈ {As}_{l} , \\ n \leq {p}_{{i}_{1} {i}_{2}} + {\sum }_{( {i}_{1} , {i}_{2} ) ∈ {I}_{as}} 1$$

$$∀ ( {i}_{1} , {c}_{1} ) ∈ {I}_{c} , ( {i}_{2} , {c}_{2} ) ∈ {I}_{c} : {c}_{1} \neq {c}_{2} ∃ ( {c}_{1} , {c}_{2} , n ) ∈ {As}_{u} , \\ n \geq {\sum }_{( {i}_{1} , {i}_{2} ) ∈ {I}_{as}} 1 - {q}_{{i}_{1} {i}_{2}}$$

In this embodiment, a further constraint is used to relate instances in the model back to the root node through a compositional relationship (this can be either directly or indirectly). This further constraint ensures that, if a new instance is required to satisfy an association relationship, the appropriate composition relationship will also be constructed. The further constraint can be expressed as:

$$∀ {c}_{1} , {c}_{2} ∈ C , {\sum }_{( i , {c}_{2} ) ∈ {I}_{c}} 1 \leq {\sum 1}_{( {i}_{1} , {i}_{2} ) ∈ {I}_{co} : ( {i}_{1} , {c}_{1} ) ∈ {I}_{c} ⋀ ( {i}_{2} , {c}_{2} ) ∈ {I}_{c}} + {\sum }_{( {i}_{1} , {c}_{1} ) , ( {i}_{2} , {c}_{2} ) ∈ {I}_{c}} {x}_{{i}_{1} {i}_{2}}$$

The above described constraints advantageously provide that the number of instantiations of containments and associations (as defined by those in the input partial mapping model, and those that are added and removed by the decision variables) are within the bounds specified in the mapping meta-model 10.

In other embodiments, a different set of constraints is used.

For example, in other embodiments the following constraints are used:

$$∀ {c}_{1} , {c}_{2} ∈ C$$

$$f ( {c}_{1} , {c}_{2} , {Co}_{l} ) \leq {\sum }_{( {i}_{1} , {c}_{1} ) , ( {i}_{2} , {c}_{2} ) ∈ {I}_{c}} ( {i}_{1} , {i}_{2} ) ∈ {I}_{co} + {\sum }_{( {i}_{1} , {c}_{1} ) , ( {i}_{2} , {c}_{2} ) ∈ {I}_{c}} ( {x}_{{i}_{1} {i}_{2}} - {y}_{{i}_{1} {i}_{2}} )$$

$$f ( {c}_{1} , {c}_{2} , {Co}_{u} ) \geq {\sum }_{( {i}_{1} , {c}_{1} ) , ( {i}_{2} , {c}_{2} ) ∈ {I}_{c}} ( {i}_{1} , {i}_{2} ) ∈ {I}_{co} + {\sum }_{( {i}_{1} , {c}_{1} ) , ( {i}_{2} , {c}_{2} ) ∈ {I}_{c}} ( {x}_{{i}_{1} {i}_{2}} - {y}_{{i}_{1} {i}_{2}} )$$

$$f ( {c}_{1} , {c}_{2} , {As}_{l} ) \leq {\sum }_{( {i}_{1} , {c}_{1} ) , ( {i}_{2} , {c}_{2} ) ∈ {I}_{c}} ( {i}_{1} , {i}_{2} ) ∈ {I}_{as} + {\sum }_{( {i}_{1} , {c}_{1} ) , ( {i}_{2} , {c}_{2} ) ∈ {I}_{c}} ( {p}_{{i}_{1} {i}_{2}} - {q}_{{i}_{1} {i}_{2}} )$$

$$f ( {c}_{1} , {c}_{2} , {As}_{u} ) \leq {\sum }_{( {i}_{1} , {c}_{1} ) , ( {i}_{2} , {c}_{2} ) ∈ {I}_{c}} ( {i}_{1} , {i}_{2} ) ∈ {I}_{as} + {\sum }_{( {i}_{1} , {c}_{1} ) , ( {i}_{2} , {c}_{2} ) ∈ {I}_{c}} ( {p}_{{i}_{1} {i}_{2}} - {q}_{{i}_{1} {i}_{2}} )$$

where f( ) returns a cardinality value from the meta-model for a given class and relationship type, for example:

$$f ( {c}_{1} , {c}_{2} , Ref ) = \{ \begin{matrix}n & if ( {c}_{1} , {c}_{2} , n ) ∈ Ref \\ 0 & if ( {c}_{1} , {c}_{2} , n ) ∉ Ref\end{matrix}$$

In these other embodiments, a further constraint that all instances in the model are related to the root node through a containment relationship, either directly or indirectly may also be used. This further constraint tends to ensure that, if a new instance is required to satisfy an association relationship, the appropriate containment relationship will also be constructed. This further constraint may be expressed as:

∀(i₁,c₁),(i₂,c₂)εI_{C}:f(c₁,c₂,Coᵤ)>0

1=Σ(i₁,c₁,i₂,c₂)εI_{CO}+x(i₁,c₁,i₂,c₂)−y(i₁,c₁,i₂,c₂)

Also in these other embodiments, the combination of these constraints state that the number of instantiations of containments and associations (as defined by those in the input model, and those that are added and removed by the decision variables) must be within the bounds specified in the meta-model.

Also, an objective function is used in the performance of step s24. In this embodiment this objective function is as follows:

$$min ( {\sum }_{( {i}_{1} , {c}_{1} ) ∈ {I}_{c} , ( {i}_{2} , {c}_{2} ) ∈ {I}_{c}} ( {x}_{{i}_{1} {i}_{2}} + {y}_{{i}_{1} {i}_{2}} + {p}_{{i}_{1} {i}_{2}} + {q}_{{i}_{1} {i}_{2}} ) )$$

This objective function provides that the number of changes performed on the partial mapping model to ensure that it conforms to the mapping meta-model 10 is minimised.

Thus, steps s22 and steps s24 define and relate an appropriate number of instances of classes, given the relevant meta-model, making the minimum number of changes to the existing model as possible. For these steps the constraints and objective functions are constant irrespective of the detail within the models.

At step s26, the attribute values of the instances are set to produce a complete, viable mapping model.

In this embodiment, permissible values for the model attributes are dependent on the specific constraints specified by the mapping meta-model 10. The decision variables, constraints and objective functions are all meta-model specific.

In this embodiment, each unique meta-model constraint is incorporated into the Constraint Satisfaction Problem. In particular, in this embodiment each relevant OCL constraint is uniquely expressed in GMPL. These GMPL expressions may be determined either manually, e.g. by a user, or automatically, e.g. from the OCL representations of the constraints. This provides that the MILP solver may be used to determine valid attribute values, rather than just verifying the existing attribute values.

Thus, a complete mapping model is generated by solving the above described Constraint Satisfaction Problem. Valid attribute values for the complete mapping model, which can then be propagated to generate the vehicle model, are determined using constraints specified by the mapping meta-model 10.

In embodiments in which a value of only one attribute is required to be set, this attribute value may be set as the target of the MILP to be solved. In embodiments in which the values of multiple attributes are unknown (and that need to be set), each attribute may be represented as a distinct decision variable and the MILP solver may be used to determine acceptable values for each attribute (if a feasible solution exists).

An advantage provided by the process performed at step s26 is that sufficient or optimal values may be calculated for any unspecified attributes. This is in contrast to the approach described in Cabot et al which addresses a problem of verifying a set of pre-existing attributes only.

Thus, a method of completing the partial mapping model to produce a complete, viable mapping model is provided.

An advantage provided by the above described embodiments is that, given a task, a set of functions that allows a system/vehicle to perform that task tends to be identified.

A further advantage provided by the above described embodiments is that a capability of, during design-time and/or run-time, determining capabilities for a system to enable that system to perform a given task tends to be provided. Due to the complexities and uncertainties of the environments in which some autonomous systems are to operate in, it tends not to be appropriate to consider the determining of capabilities for a system as solely a design-time activity. This problem is addressed by the above described embodiments by providing a capability to determine capabilities during run-time. The circumstances and context in which the system will be used tend to be able to be determined with greater accuracy during run-time. The above described method advantageously exploits this improved information.

A system for implementing the above described embodiment advantageously tends to portable (e.g. may be mounted on and carried by an autonomous vehicle), and reusable (i.e. may reused for different tasks and/or on different vehicles by modifying the relevant model/module 8, 9, 10, 12).

A further advantage of the above described embodiments is that the problem to be solved, a solution that may address that problem, and the specific implementation details of that solution are clearly separated. This tends to facilitate a user's understanding of the results of the model generation process and the options available to the user.

A further advantage provided by the above embodiments is that the task model, the vehicle model, the mapping model and the model transform system are separately defined entities. This advantageously tends to provided that one or more of these models may be changed/revised by a user without the need to alter the other models, i.e. the above described system for verifying the state of the vehicle with respect to the task has a degree of modularity.

A further advantage is that a properly defined CIM (task model) may be reused both as a goal state to attain when determining the actions an autonomous system will have to carry out to achieve that state, and as an initial state which may be used as the basis of a run-time verification framework and ‘transformed’ into the PIM/PSM system model.

A further advantage is that any of the models (i.e. task or vehicle models) and/or any of the information contained in the model transform system, tend to be able to be altered at any time (either remotely or directly). This advantageously provides that the information used to verify/validate the vehicle may be changed easily, for example, if the task changes or the vehicle capabilities need to be revised.

A further advantage provided by the above described method and apparatus is that superfluous relationships between instances within an over-specified model are removed. This tends to provide that the above described method is relatively efficient.

The specification of model transformations can be complicated and prone to errors. A further advantage provided by the above described method and apparatus is a means to ‘fix’ the results of a model transformation operation is tends to be provided. Thus, it tends to be easier to specify model transformations.

It should be noted that certain of the process steps depicted in the flowcharts of FIGS. 3 and 4, and described above may be omitted or such process steps may be performed in differing order to that presented above and shown in the Figures. Furthermore, although all the process steps have, for convenience and ease of understanding, been depicted as discrete temporally-sequential steps, nevertheless some of the process steps may in fact be performed simultaneously or at least overlapping to some extent temporally.

Apparatus for implementing the system 5, and performing the above described method steps, may be provided by configuring or adapting any suitable apparatus, for example one or more computers or other processing apparatus or processors, and/or providing additional modules. The apparatus may comprise a computer, a network of computers, or one or more processors, for implementing instructions and using data, including instructions and data in the form of a computer program or plurality of computer programs stored in or on a machine readable storage medium such as computer memory, a computer disk, ROM, PROM etc., or any combination of these or other storage media.

In the above embodiments, the vehicle is an autonomous land-based vehicle. However, in other embodiments the vehicle is a different type of vehicle, for example an unmanned air vehicle.

In the above scenarios/embodiments, the task comprises the vehicle autonomously navigating along the road, from a first point A to a second point B. However, in other scenarios/embodiments the task is a different task, for example a task comprising any number of sub-tasks, e.g. navigating from one position to another, avoiding certain obstacles, surveying an area, surveillance and/or interception of an entity, collecting, transporting and/or delivery of a load etc. Moreover, a task may require the vehicle to operate in any environmental conditions. One or more sensors may be used to provide data about environmental conditions in which the autonomous vehicle operates, and this data may be used in the above described method (e.g. by incorporating it into the task model). Also, one or more sensors may be used to provide information about actions that are to be performed by the autonomous vehicle to perform the task, and this data may be used in the above described method (e.g. by incorporating it into the task model).

Any of the models and components of the system (i.e. the task model, the vehicle model, the mapping model, the model transform system, the processor, and the display) may be wholly, or partially situated onboard the vehicle. Also, any of the models and components of the system may be remote from the vehicle.

In the above embodiments, the task model is user defined. The other models (i.e. the mapping and vehicle models) are automated. However, in other embodiments one or more of the models and/or some or all of the information in the model transform system may be provided in a different way. For example, in other embodiments, information about environmental conditions in which the vehicle is operating and/or information about actions that may be performed by the vehicle may be provided by one or more appropriate sensors. Data provided by sensors typically has uncertainty associated with it. In such cases the data may be interpreted, combined or fused in order to perceive pertinent information.

In the above embodiments, the model generation process is implemented using a QVT transformation language. However, in other embodiments, a different appropriate language is used.

In other embodiments the task meta-model may be represented using any appropriate language or languages, e.g. Planning domain Definition Language (PDDL), Systems Modelling Language (SysML), The Architecture Analysis & Design Language (AADL), OWL Web Ontology Language, Unified Modelling Language (UML) etc.

In other embodiments the vehicle meta-model may be represented using any appropriate language or languages, e.g. Planning domain Definition Language (PDDL), Systems Modelling Language (SysML), The Architecture Analysis & Design Language (AADL), OWL Web Ontology Language, Unified Modelling Language (UML) etc.

In other embodiments the mapping meta-model may be represented using any appropriate language or languages, e.g. Planning domain Definition Language (PDDL), Systems Modelling Language (SysML), The Architecture Analysis & Design Language (AADL), OWL Web Ontology Language, Unified Modelling Language (UML) etc.

In this embodiment, the modelling languages used to express the task model during the design-time are the same as those used to express the task model during the run-time. However, in other embodiments different modelling languages are used (to express one or more of the models) during design-time and run-time. In certain situations, representations for the models at design-time may not be used directly during run-time without modification. Also, the scope of the models may not necessarily be the same during design-time and run-time. Some design-time information may be redundant at run-time, hence including it tends to be unnecessary and may slow processing. Similarly, some information will only be available at run-time, so including it explicitly in design-time models adds to their complexity.

In other embodiments, the above described design-time/run-time difference is addressed by implementing a Runtime Specific Model (RSM) with additional model transformations specified between it and the PSM. The RSM uses runtime specific representations, and only includes information relevant to run-time operation. This tends to reduce the need for non-relevant information being included in the models at run-time. However, the distinction between run-time task models and run-time system models ends to be hidden by this approach.

In other embodiments, the above described design-time/run-time difference is addressed by implementing distinct sets of MDA models for design-time and run-time, which are related by ‘design-time to run-time’ model transformations. In other words, in other embodiments different modelling representations are used in design-time compared to run-time. This tends to allows for the use of appropriate representations at both design-time and run-time, and tends to allows for the specification of the run-time CIM as distinct, but related to, the design-time CIM. Therefore, run-time ‘problems’ tend to be advantageously related to run-time ‘system solutions’.

In the above embodiments, the model of a vehicle capable of performing a given task is generated by determining an intermediate model (the mapping model) from the task model and a set of permitted transformations, and determining a vehicle model from that intermediate model and a set of permitted transformations. However, in other embodiments a different number of intermediate (mapping) models may be used, and the model of a vehicle capable of performing a given task may be determined using a transformation from the task model to the vehicle model via any number of the different models, e.g. in other embodiments there are no mapping models.

In the above embodiments, to evaluate the vehicle with respect to the task, it is determined whether there exists a transformation (i.e. a transformation trace) between the task model and the first vehicle model, and a transformation (i.e. a transformation trace) between the first vehicle model and the second vehicle model. In other words, task meta-models and vehicle meta-models are related directly.

In other embodiments, a different strategy for organising model transformations is used to evaluate vehicle capabilities with respect to a task.

For example, a single n-way model transformation which references all of the relevant meta-models may be used. Typically, model transformations are expressed between two models. However, some model transformation representations (for example, QVT-Relation) allow arbitrary numbers of meta-models to be referenced. Thus, a single transformation may be used to cover all domains. QVT-Relation advantageously tends to separates out the domains for each relation that makes up a transformation specification.

In the above embodiments, an identified set of functions that allows a system/vehicle to perform a given task tends not to be optimal. However, in other embodiments a “best” set of system functions for performing a task is identified.

This “best” set of system functions for performing a task may be identified in any appropriate way. For example, if all the models representing valid combinations of functionality are generated, each of these models may be evaluated to determine which is best according to some metric. However, this process tends not to scale well as the size of the models, and the number of relations between models, increases. In other embodiments, a model transformation engine that selects a preferred relation from a set of sufficient relations is implemented. In other embodiments, a model transformation engine that evaluates sufficient relations based on the underlying models is implemented.

In the above embodiment, at step s14, the method described above with reference to FIG. 4 is used to complete the partial mapping model. However, in other embodiments a different process is used to complete the partial mapping model. For example, an “in-place” (i.e. within the mapping model domain) transformation is implemented. In such embodiments a set of relations to complete the model is manually specified.

In the above embodiments, a vehicle model is generated by specifying only a task model. In other words, a task model is specified which is used to generate a partial mapping model. This partial mapping model is completed and used to generate a vehicle model. However, in other embodiments a model is generated in a different appropriate way.

For example, in other embodiments a task model is generated by specifying only a vehicle model. In other words, a vehicle model is specified which is used to generate a partial mapping model. This partial mapping model is completed and used to generate a task model.

In other embodiments, both a vehicle model and a task model are specified. Both of these models may be used to generate a mapping model which is a partial mapping model. This partial mapping model is then completed.

In this embodiment, the framework used for the meta-model and model generation/specification is the Meta-Object Facility (MOF) approach. However, in other embodiments a different appropriate framework is used. For example, in other embodiments, the ECORE framework, which is part of the Eclipse Modelling Framework, is used. In other embodiments, the framework used for a model generation process (i.e. generating/specifying a model) is the Model Driven Architecture (MDA) approach. MDA describes an architectural approach for organising models and meta-models. More information about MDA may be found in “MDA Guide v1.0.1”, J. Miller & J. Mukerji, OMG, 2003, which is incorporated herein by reference.

1. A method comprising:
providing a first meta-model, the first meta-model providing a basis for a first model;
providing a second meta-model, the second meta-model providing a basis for a second model;
providing a first model, the first model being an instantiation of the first meta-model and
using the first model and a set of transformations between the first meta-model and the second meta-model, determining the second model, the second model being an instantiation of the second meta-model; wherein:
either,
the first model corresponds to a given task;
the second model corresponds to an autonomous vehicle; and
the method further comprises providing an autonomous vehicle as specified by the second model;
or
the first model corresponds to a given autonomous vehicle;
the second model corresponds to a task; and
the method further comprises using the given autonomous vehicle to perform the task specified by the second model.

2. A method according to claim 1, the method further comprising providing a third meta-model, the third meta-model providing a basis for specifying an intermediate model, wherein the step of determining a second model comprises:
using the first model and a set of transformations between the first meta-model and the third meta-model, determining a third model, the third model being an instantiation of the third meta-model; and
using the third model and a set of transformations between the third meta-model and the second meta-model, determining the second model.

3. A method according claim 2, wherein the step of determining a third model comprises:
using the first model and a set of transformations between the first meta-model and the third meta-model, determining a partially complete model; and
determining the third model by completing the partially complete model.

4. A method according claim 3, wherein the step of completing the partially complete model comprises:
determining a finite set of instantiations of the third meta-model; and
dependent upon constraints specified in the third meta-model, setting values of attributes of one or more of the instances.

5. A method according to claim 4, wherein the step of completing the partially complete model further comprises explicitly relating instantiations in the finite set by generating or removing an association and/or containment relationship between those instantiations.

6. A method according to claim 3, wherein the step of completing the partially complete model comprises representing the problem of completing the partially complete model as a Constraint Satisfaction Problem, and solving the Constraint Satisfaction Problem.

7. A method according to claim 6, wherein the step of completing the partially complete model further comprises representing the Constraint Satisfaction Problem as a Linear Program in the Gnu Mathematical Programming Language, and solving the Constraint Satisfaction Problem using a Mixed Integer Linear Programming solver.

8. A method according to claim 3, wherein an objective of the step of completing the partially complete model is to complete the partially complete model by making a minimum number of changes to the partially complete model.

9. A method according to claim 1, the method further comprising using one or more sensors to provide data about environmental conditions in which the autonomous vehicle is to operate, and using that data in the method.

10. A method according to claim 1, wherein each meta-model and model is in accordance with the Meta Object Facility approach for the development of software systems.

11. Apparatus comprising one or more processors arranged to, using a first model, the first model being an instantiation of a first meta-model, and a set of transformations between the first meta-model and a second meta-model, determine a second model, the second model being an instantiation of the second meta-model; wherein:
either,
the first model corresponds to a given task;
the second model corresponds to an autonomous vehicle; and
the apparatus further comprises means for providing the autonomous vehicle specified by the second model;
or
the first model corresponds to a given autonomous vehicle;
the second model corresponds to a task; and
the apparatus further comprises the given autonomous vehicle.

12. An autonomous vehicle comprising one or more processors arranged to, using a first model, the first model being an instantiation of a first meta-model, and a set of transformations between the first meta-model and a second meta-model, determine a second model, the second model being an instantiation of the second meta-model; wherein:
the first model corresponds to the autonomous vehicle; and
the second model corresponds to a task.

13. An autonomous vehicle according to claim 12, wherein the autonomous vehicle is a land-based autonomous vehicle.

14. (canceled)

15. (canceled)

16. One or more non-transient machine readable storage mediums encoded with instructions that when executed by one or more processors cause a method to be carried out, the method comprising the method of claim 1.

17. One or more non-transient machine readable storage mediums according to claim 16, the method further comprising providing a third meta-model, the third meta-model providing a basis for specifying an intermediate model, wherein the step of determining a second model comprises:
using the first model and a set of transformations between the first meta-model and the third meta-model, determining a third model, the third model being an instantiation of the third meta-model; and
using the third model and a set of transformations between the third meta-model and the second meta-model, determining the second model.

18. One or more non-transient machine readable storage mediums according to claim 17, wherein the step of determining a third model comprises:
using the first model and a set of transformations between the first meta-model and the third meta-model, determining a partially complete model; and
determining the third model by completing the partially complete model.

19. One or more non-transient machine readable storage mediums according to claim 18, wherein the step of completing the partially complete model comprises representing the problem of completing the partially complete model as a Constraint Satisfaction Problem, and solving the Constraint Satisfaction Problem.

20. One or more non-transient machine readable storage mediums according to claim 19, wherein the step of completing the partially complete model further comprises representing the Constraint Satisfaction Problem as a Linear Program in the Gnu Mathematical Programming Language, and solving the Constraint Satisfaction Problem using a Mixed Integer Linear Programming solver.

21. One or more non-transient machine readable storage mediums according to claim 18, wherein an objective of the step of completing the partially complete model is to complete the partially complete model by making a minimum number of changes to the partially complete model.

22. One or more non-transient machine readable storage mediums according to claim 18, wherein the step of completing the partially complete model comprises:
determining a finite set of instantiations of the third meta-model; and
dependent upon constraints specified in the third meta-model, setting values of attributes of one or more of the instances;
wherein the step of completing the partially complete model further comprises explicitly relating instantiations in the finite set by generating or removing an association and/or containment relationship between those instantiations.
